(19) United States
(12) Patent Application Publication
(10) Pub. No.: US 2017/0225303 A9
(43) Pub. Date: Aug. 10, 2017

(54) TORQUE TOOL FOR B-NUT FITTING

(71) Applicant: David, Jr. Wilson, JR., Boulder, CO (US)

(72) Inventor: David, Jr. Wilson, JR., Boulder, CO (US)

(21) Appl. No.: 14/838,391

(22) Filed: Aug. 28, 2015

Related U.S. Application Data
(60) Provisional application No. 62/043,272, filed on Aug. 28, 2014.

(51) Int. Cl. B25B 13/46; B25B 23/14; B25B 23/00; B25B 13/48

(52) U.S. Cl. CPC B25B 13/467; B25B 13/481; B25B 23/14; B25B 23/0007

(57) ABSTRACT

A reciprocating apparatus for high torque transfer to a fitting, including tightening or loosening, having two coaxially synchronized engageable drive members provided with a sector geared radial flange engageable with an engageable rotatable drive gear, one internally supported split ratchet gear and drive socket maintained in contact with a spring biased ratchet pawl, together simultaneously rotatable in a first driving direction and independently disengageable in a second direction for reciprocative advancement of a ratchet geared socket in driving engagement with a fitting.

### PROBLEM REQUIRING RESOLUTION

During the assembly of aircraft and vessels, runs of tubing, pipe and conduit are installed for transportation of fluids to various locations throughout these massive machines. Straight fittings, elbow unions, cross-unions, valves and gauges are used to connect fuel lines, air lines, hydraulic lines, and valve actuators within the confines of these machines without leaks where the available space for fittings is at an absolute minimum which forces fittings to be grouped closely together making installation challenging. The larger the fitting is, the more difficult the assembly task becomes corresponding to increasing torque requirements and the large tools required to properly install each fitting. Large fittings can require over 400 ft-lb's. of torque to install, making hand assembly nearly impossible to accomplish sufficiently to prevent leaks. While leaking fuel lines promote the risk of fire, leaking chemical lines can result in chemical burns that are also extremely dangerous. The present invention provides a compact torque application strategy for assembling these fittings by utilizing driving gears to rotate co-axially pivoted open end ratchet wrenches.

### DESCRIPTION

Described is a powerful and highly compact method of rotating a ratcheting crowfoot style wrench with gear teeth cut around of the wrench head. The new invention is an effective driver for fixed jaw or ratcheting open-end crow-foot wrench heads. The present invention enables the application of precise torque values while installing fluid fittings with hand tools or adapted electric or pneumatic power tools. In one embodiment, the device includes the following elements:

The present invention is for the installation or removal of fluid fittings such as B-nuts, hydraulic fittings onto tubing, pipe, or hoses. The new tool is useful for securing fittings located on elbow, T's, and Cross unions joining tubing runs with manifolds, valves, pumps and successive lengths of tubing. The present invention is compact and powerful allowing measured torque valves to be applied to critical connections in confined quarters.

The present invention is comprised of two detachable components. Each of the components is provided with specific features to allow the two components to be engaged with a common fitting connection to facilitate accurate rotation of the fitting to a specific torque value, while working together as a unit. A first component is used to hold the body of the fitting in a stationary position. This first component includes a slotted hub, arm, and a rotably supported drive gear. The drive gear is provided at the end of the arm opposite the slotted opening in the hub. The hub is slotted to provide an opening for engagement with a non rotable feature of the fitting body (for instance the center nut of fitting). The drive gear is disposed at a distance from the center of the slotted hub equal to the specified gear mounting distance required for meshed engagement of a driven sector gear, which extends around a portion of the outer perimeter of the housing of the second component.

The second component is comprised of unique features including a drive housing for a ratchet toothed drive socket for rotation of a fitting. Both the ratchet socket and geared housing are slotted equally to allow placement onto a closed circuit tubing run. The outer housing perimeter is provided with a series of gear teeth opposite the slotted front opening of the drive housing. The bottom face of the drive housing includes a hub receiving pocket, to allow the drive housing to rotate to the extents of the sector gear teeth in either a forward or rearward direction while pivoting upon the outer perimeter of the slotted hub of the first component. This enables reciprocation movement of the drive housing to engage spring biased ratchet pawls supported within the drive housing with the ratchet toothed socket which is supported for rotation on hubs within the drive housing to enable rotation of a fitting in a continuous direction. The ratchet toothed drive socket is supported for rotation within the body of the sector geared drive housing on slotted circular hubs extending from each face of the ratchet tooth drive socket. A first hub is disposed within a race within the drive housing and the second hub extends outwardly beyond the cover of the upper face of the housing providing an extended drive socket for engagement with a fitting nut undergoing rotation. A locking mechanism is provided for maintaining the slotted hub of the first component in rotative alignment with the hub pocket disposed on the bottom face of the second component.

Together, the two components are individually attached to a fitting with the first component on the fitting body and the second component engaged with the fitting nut. The two components are engaged together for cooperative interaction to function as a unitary installation tool for fittings. By allowing the first components stationary slotted hub and pinion drive gear to be maintained in meshed engagement with the pivotally supported sector gear ratchet drive housing of the second component.

Various configurations of the present invention are possible depending on torque required to complete a fitting installation. Fittings requiring high torque values are achieved by attaching a planetary torque multiplier to the present invention. Additionally, high accuracy torque output values are enabled with the addition of an electronic strain gauge or a mechanical clutch.

Fittings that do not require high torque values can be installed without the addition of a torque multiplier by utilizing the basic mechanical advantage provided by the tools pinion drive gear engaged with the sector gear of the ratchet drive housing which provides 5 to 1 mechanical advantage in a basic configuration and is variable during design of the tool to meet specific requirements.

The intent of the present invention is to provide a tool that can be placed on a fitting connection attached to a tube or hose to insure accurate tightening of a fitting by applying a measured torque value to the fitting. This is accomplished by using a set of meshed gears to rotate a ratchet drive housing pivoting on a slotted hub to incrementally reposition the ratchet housing in reciprocating forward and rearward displacements to allow the ratchet drive housing to engage with the teeth of the hub supported ratchet wheel and hexagonal drive socket to rotate a fitting in either a continuous clockwise direction or counter clockwise direction.

The ratchet drive housing can be provided with left hand ratchet teeth and complimentary drive dogs, or right hand ratchet teeth and complimentary drive dogs to support clockwise or counter clockwise rotation of fittings enabling the tool to install or remove fittings. Alternative adaptations provide for drive housings that are configured to be turned over, for reversing rotation of driving direction.

In other circumstances the ratchet drive housing can be provided with switch selected dogs and a universal ratchet tooth enabling selection of left or right rotation without leaving placement on an engaged fitting.

Accuracy of the present invention is confirmed by comparing the input torque applied through a strain gauge input shaft and comparing the output torque achieved at the hexagonal output drive socket of the ratchet gear with a torque testing machine. This allows the tool to be certified for torque accuracy and verified repeatability.

In factory assembly environments the input torque delivered to the planetary torque multiplier is easily regulated with a spring biased clutch. This allows output torque to be limited to a peak value based on the release point of the clutch.

The present invention is provided as a manual assembly tool for use in confined spaces to eliminate air hoses, hydraulic hoses and drive motors to keep the size of the tool at a minimum for ease of use. In areas where work space is open the tool is easily adapted for attachment to a wide range of power tools. For instance the planetary torque multiplier could be attached to electric nut runner or hydraulic tool each of which is well known within the art.

A slotted sector geared ratchet drive housing is provided with a semi-arcuate section of gear teeth around its perimeter at a position opposite the slotted opening of the housing. The housing is provided with pivoted blades for capture or release of the housing with a slotted circular pivot hub established for maintaining the sector geared ratchet housing in meshing contact with an arm supported drive gear. In one embodiment, a drive gear is coupled with a planetary torque multiplier provided for torque multiplication by rotation of an input shaft which is monitored by a torque sensing strain gauge to allow workers to accurately apply precise torque values to B-nut fluid fittings.

When fitted with optional accessories such electric or pneumatic reciprocating drive assemblies the present invention is easily adapted for automatic reciprocating rotation of the geared tool housing to advance the ratchet drive socket of the tool in a constant clockwise direction.

Ratchet wrench heads are provided with locking pawls configured for either clockwise or counterclockwise rotation, or can be universally adapted by simply flipping the wrench head over to facilitate installation or removal of fittings.

Various configurations of the present invention include a fixed jaw crowfoot head with a sector geared rear annulus, and is coupled with an alignment pivot hub and driven with a an arm supported spur gear to engage with the sector gear case of a ratcheting crows foot or a sector geared non ratcheting crows foot. In yet another embodiment a worm gear can be used to rotate a worm tooth sector around the perimeter of the ratchet housing.

A locking mechanism comprised of pivoted retractable blades is provided to couple the slotted alignment hub with the crowfoot heads integrated sector gear.

A slotted sector geared ratchet housing is provided with plurality of gear teeth extending around the rear perimeter of the wrench head at a position opposite the slotted opening of the ratchet housing and pivot pocket at the front of the wrench head to enable assembly and disassembly of B-nuts in constrained quarters.

### DESCRIPTION OF A PREFERRED EMBODIMENT

The body of the ratchet housing (16) is provided with a sector geared annulus (19) around the outside perimeter of the housing at a position opposite the slotted opening (24) at the front of the housing extending into a ratchet gear receiving counter bored pocket (15) that is provided in the upper surface of the housing for rotably enclosing a ratchet wheel (12) provided with upper and lower hubs (11, 13), which extend into circular openings (20) in the housing and through the housing cover (25) provided to support rotation of the hubs. Two spaced apart pockets (18) are counter bored into the housing to hold spring (27) biased pivoted ratchet dogs (26) in contact with an inserted ratchet wheel (12) to translate reciprocating rotation of the sector gear ratchet housing engaged in contact with the pinion gear (46) to incrementally advance the toothed ratchet wheel in a continuous clockwise or counterclockwise direction. The lower surface of the ratchet housing (21) opposite the cover is provided with a slotted hub receiving pivot pocket (23). The pocket is comprised of two diametrically opposed arcuate walls (22) sized for receipt of a slotted pivot hub (4). The slotted pivot hub includes an arm (3) extending a length coincident with the mounting distance of a rotably supported pinion gear, in a bearing pocket (2) to insure meshing engagement with the sector geared housing.(19). The pinion gear support arm (3) is formed integral with a slotted circular hub (4) including two spaced apart side walls spaced for engagement with a non rotable feature of a fitting (10) at a first end and a pinion gear mounting pocket (2) at a second end. When the slotted hub (4) is inserted into the hub receiving pocket (23) established by the downwardly extending arcuate walls (22), the two diametrically opposed arcuate walls are spaced apart at distance for rotating engagement with the slotted hub (4), to insure accurate rotation and alignment with the sector geared ratchet housing (16) when pivoting upon the slotted hub. This allows the two components to be securely coupled together by a locking mechanism comprised of retractable pivoted curved blades (36) that are actuated with a spring (33) biased key (30) enabling forward and aft movement of the key, while interacting with the pivoted blades (36) resulting in extension or retraction of the pivoted blades into slots (17) provided with the inner annulus of the spaced apart walls (22) of the sector geared ratchet housing (16). These cooperating components are arranged to allow forward travel of the key (30) to make contact with the curved blades (36) at a first end (35) resulting in the pivoted blades registering with radial slots (17) along the inner perimeter of the walls. When key is moved out of contact with the curved blades, the blades pivot out of contact with the slots along the inner perimeter of the walls assisted by an extension spring (34) attached between each blade leg end (37), the blades are maintained in shaped pockets (54) provided in the upper face of the slotted hub (4), the communicating key is secured in a inset slot (52) disposed along the central axis of the arm provided between the slotted hub (4) and the pinion gear mounting pocket (2).

The key is maintained in communication with right angle vertically disposed rails (14) that are attached to the lower end of a planetary multiplier barrel (48) slidably captured in a semi-circular shoe (6), enabling the rails to extend from the top face of the pinion gear arm mounting pocket (2) there through two space apart passages (58) and into alignment with the sliding key (30).

Each rail is provided with radial grooves at the end of each rail (29) and disposed to engage with arms (31) on the sliding key (4), thereby enabling movement of the planetary barrel (48) to effect engagement or retraction of the curved capture blades (36) into and out of slots (17) provide around the inner perimeter of the sector gear ratchet housing pivot pocket (23) defined by two spaced apart walls. This component allows the sector geared ratchet housing to accurately pivot around the slotted pivot hub (4) supporting smooth reciprocation of the components by precision alignment and proper registration.

These orchestrated components cooperate to lock or un-lock the pivoted sector geared crowfoot into an operative position with the slotted circular hub (4) for rotation while maintaining meshed gear tooth engagement of the sector geared ratchet housing with the pinion drive gear (46). Once the grooves at the end of each rail (29) are engaged, the mechanism's key simultaneously locks the planetary drive and strain gauge module in a closed and latched position at its lowest extent (55) against the top face of the sector geared crowfoot housing to hold the sector gear of the crowfoot down against the top of the slotted pivot hub in the Z-axis. With the lower rim (57) of the planetary multiplier. When the forward nose of the key (30) contacts the bottom, ends of pivoted curved blades (36) the blades pivot outwardly into slots in the sector gear ratchet housing wall slots (17), two forward parallel arms (32) of the key (30) extend slightly beyond the neck (8) of the slotted hub arm to provide a release lever for manual retraction of the capture mechanism. Sliding the two arms away from the open slotted hub (4) at the front end of the tool allows the two pivoted blades to retract (58) inwardly withdrawing the curved blades from the inset slots (17) provided in the guide walls (22) of the sector geared ratchet housing (16). With the curved blades in a retracted position, the two components are easily separated into two individual components for removal from a fitting. The capture mechanism is fitted with a cover (38) that encloses all moving components into an inset pocket (52) and secured with screws (39) at the lower face of the slotted hub arm the cover extends over the curved blades (36) to the rear end of the arm. Diametrically opposed slotted openings (59) are provided to allow the blades to extend outwardly and to a position slightly outside the perimeter of the slotted hub annulus at a position adjacent to the upper face of the slotted hub. The slotted sector gear ratchet housing is (16) fitted with twin ratchet dogs (26) spaced apart a distance appropriate to establish a slotted entrance for a tube or pipe and provided with springs (27) biased ratchet dogs (26) for incrementally driving a slotted ratchet tooth drive wheel (12) provided within a fitting receiving socket jaw (60) maintained within a pocket (15) in the sector geared ratchet housing (16) secured in place by a slotted cover (25) securely attached with fasteners (28) the assembled unit is ready for placement onto the slotted circular pivot hub (4) and readied for driving engagement with a fitting (9), thereby allowing reciprocating rotation of the input stem (41) in forward and rearward movements to drive sector gear resulting in unidirectional ratchet advancements as small as 3 degrees or less per cycle. The ratchet wheel is provided with a hexagonal aperture (60) configured to rotate a socket within the ratchet wheel for driving engagement with a fitting (9). Output forces of over 200 ft.lbs. are easily attained by technicians with as little as 8 ft.lbs. of manual effort by simple rotation of the attached torque multiplier, slidably held in a “C” shaped drive shoe (6). The planetary torque multiplier (48) is comprised of a set of three planetary gears (51), mounted in a planetary gear carrier (44) disposed inside a geared toothed barrel (49) assembly and supported in operative position with bearings (47a,b). The output shaft of the planetary is equipped with a hex drive socket (45) for telescoping engagement with a hex shaft (61) the pinion gear captured in bearing at the arm end opposite of the slotted hub. A strain gauge (42) monitored input shaft is provided for attachment to the sun gear (43) of the planetary torque multiplier (48) for measuring precise input values as they are applied to the planetary torque multiplier. The input shaft of the strain gauge is rotated with a common ratchet wrench (40), hand wheel or rigid bar.

The planetary torque multiplier (48) is slidably maintained in a C shaped shoe (6) attached to the face of the end of the slotted hub arm (3), and includes three lug shaped slots (62) extending from the face of the arm to the top of the shoe. The planetary barrel is provided with three lugs (63) around the perimeter of the planetary barrel to support movement of the planetary torque multiplier from an extended and open position to a retracted and closed position. A vertical slot is provided along the vertical mid line of the “C” shaped mounting shoe, and includes a through slot (64) for attachment of a spring biased latch (7) extending though the slot and into the rear wall of the planetary barrel in a threaded hole (64) providing an extension or retraction stop for the planetary and strain gauge at two discreet positions in either an open or closed position to streamline component assembly. Together all components cooperate to provide a highly effective torque tool for the assembly of B nuts, and a wide range of fluid fittings on tubing, pipe and threaded shafts.

The present invention provides a compact torque delivery system for B-nut fittings and wide range of fluid fittings constrained by tight assembly conditions.

### USE OF THE PRESENT INVENTION

The tool is best employed by first engaging the sector geared ratchet housing with a hexagonal fitting requiring rotation by aligning the hex socket with the fitting flats. Next, the aligning pivot platform is inserted into co-axial pivot pocket at the rear face of the sector gear driven ratchet housing adjacent the arcuate alignment guides projecting from the lower face of the ratchet housing into seated engagement with the enlarged semi-circular shoulders of the alignment platform and locked into engagement by sliding the planetary barrel closed to its lowest extents in the planetary shoe until causing winged capture keys to capture radial slots encircling the lower end of the planetary rails and clicking into an operative position. As detailed by the preceding step by step explanation.

The input shaft of the planetary is rotated in oscillatory rotations by placement of a hand wheel, ratchet or handle stem onto the input shaft of the coupled strain gauge module and articulated by reciprocating action until the required torque value appears on the outwardly provided display window. Removal of the tool is accomplished by retracting projecting arms by sliding the parallel arms of the slide key rearward to disengage the wing shaped engagement blades for the annular grooves at the end of the spaced apart parallel planetary guide rails, causing the spring biased planetary barrel to extend upwardly releasing closing pressure against the sector geared ratchet housing, thereby providing an opening to allow the sector geared ratchet housing to be de coupled with the alignment base.

Hitherto, it should readily apparent to anyone skilled in the art that many different attachments can be manipulated with a pivoted sector geared wrench head of the present invention, when pivotally disposed upon a slotted pivot hub, the accurate description describes only one application while many other configurations are available for use. Including tightening or loosing fittings that do not require high torque the input gear of the tools could be rotated without a planetary or strain gauge.

In yet another embodiment, a simple crows foot head could be provided with a sector gear around its outer annulus and driven with a pinion gear for short travel tightening or loosing.

Extended barrels and attachments can be adapted for tightening tie rod ends or threaded shafts.

### PRIOR ART REFERENCES

Ratcheting crows foot wrenches are well described within the art:
H. L Fish U.S. Pat. No. 2,578,686 Ratchet for tubing.
H. L Fish U.S. Pat. No. 2,578,687 Ratchet for tubing.
A. Kavalar U.S. Pat. No. 2,550,010 Ratchet for tubing.
W. E Holsclaw U.S. Pat. No. 1,795,689 (sector gear pipe bender)

### Manufacturing Methods:

The present invention is comprised of modular pieces for economical manufacturing. Chrome molly steel is preferred production material but any suitably strong metal could be successfully employed.

The tool is manufactured by conventional means such a lathe, and milling machine, many modern assembly methods are easily adapted to production of the invention such metal injection molding, laser, water jet and others readily apparent to those skilled in the art of tool manufacturing.

### FIGURES

FIG. 1. Exploded view pivot housing and sector geared ratchet.

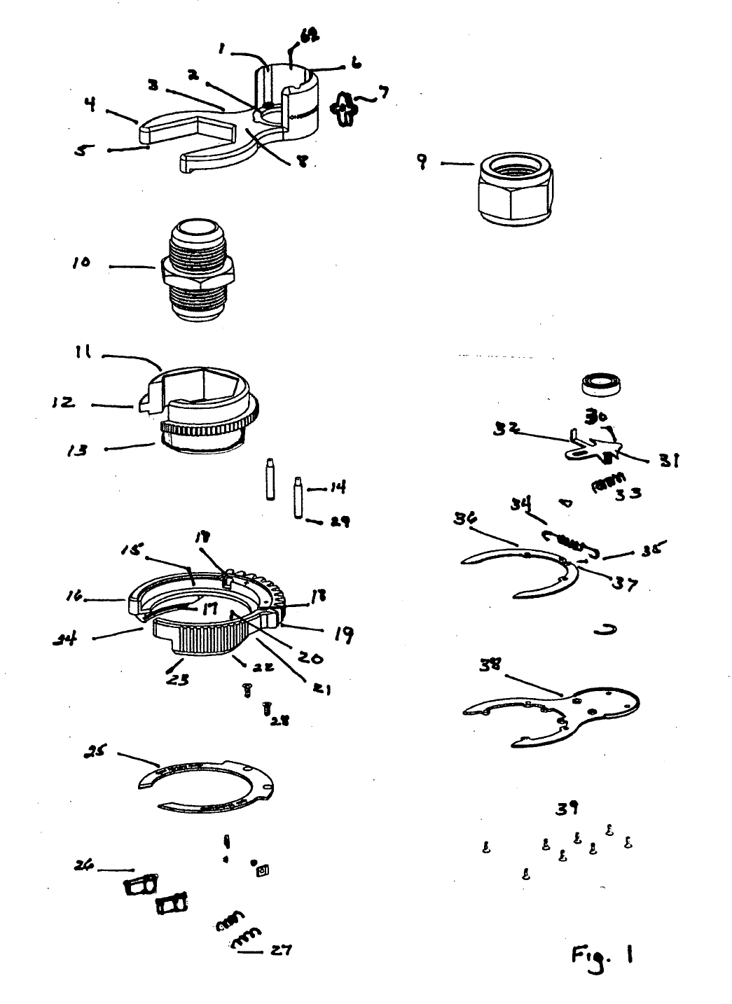

FIG. 2. Exploded view of strain gauge and planetary multiplier.

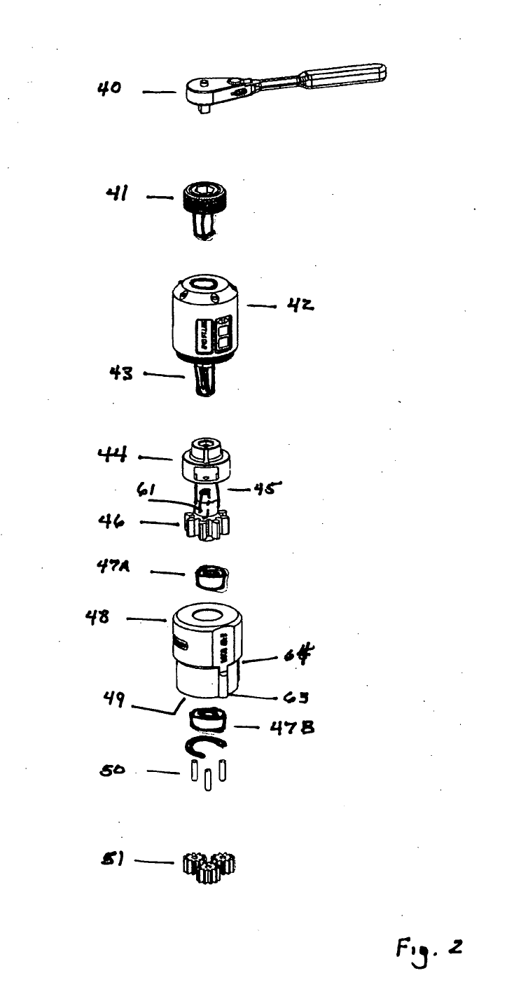

FIG. 3. Capture mechanism in deployed position.

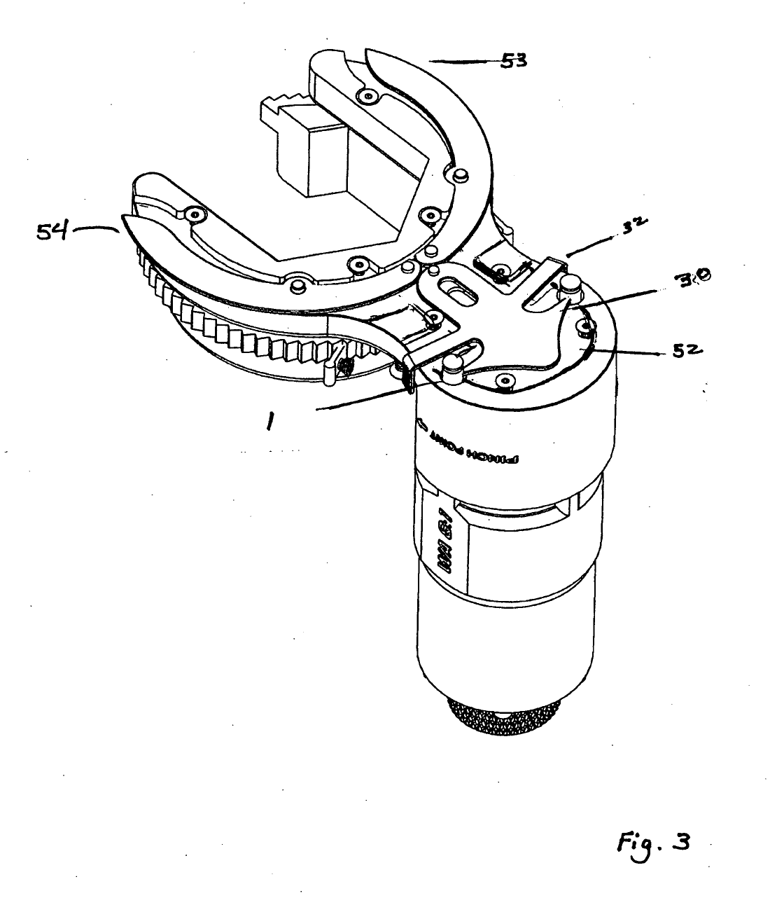

FIG. 4. Rear slot and latch assembly.

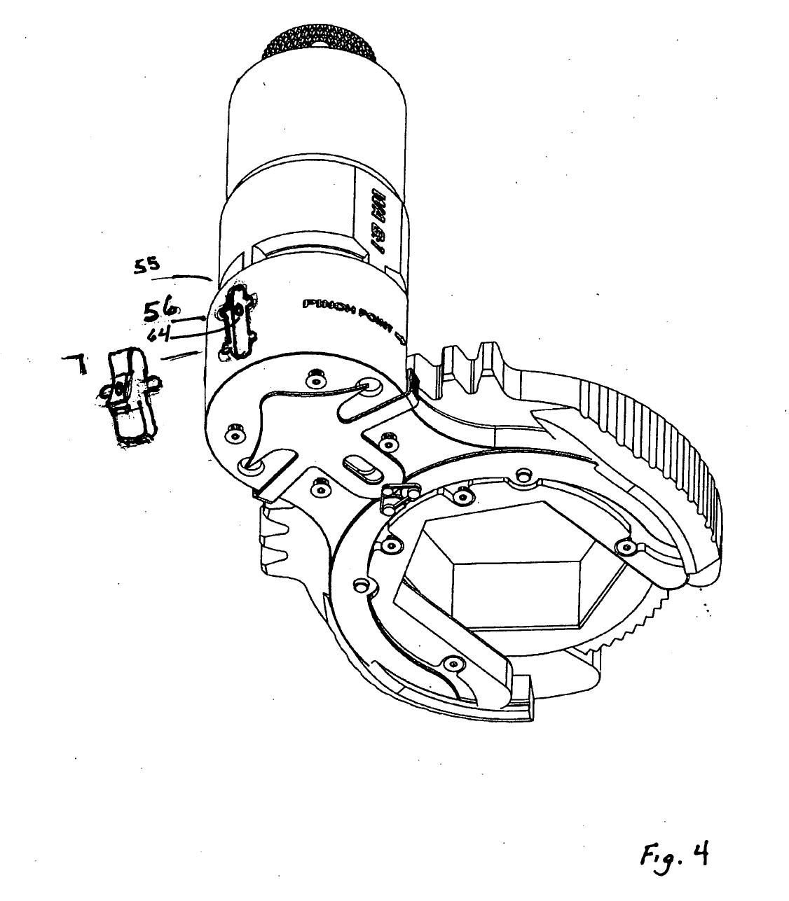

FIG. 5. Pivot hub detached from sector geared ratchet.

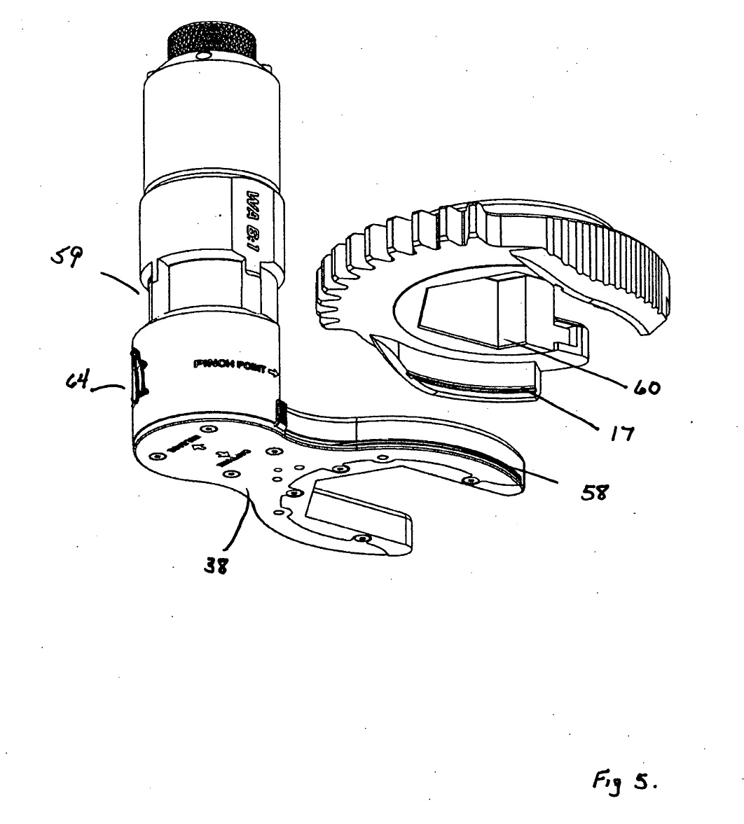

FIG. 6. Entry slot for insertion sector gear.

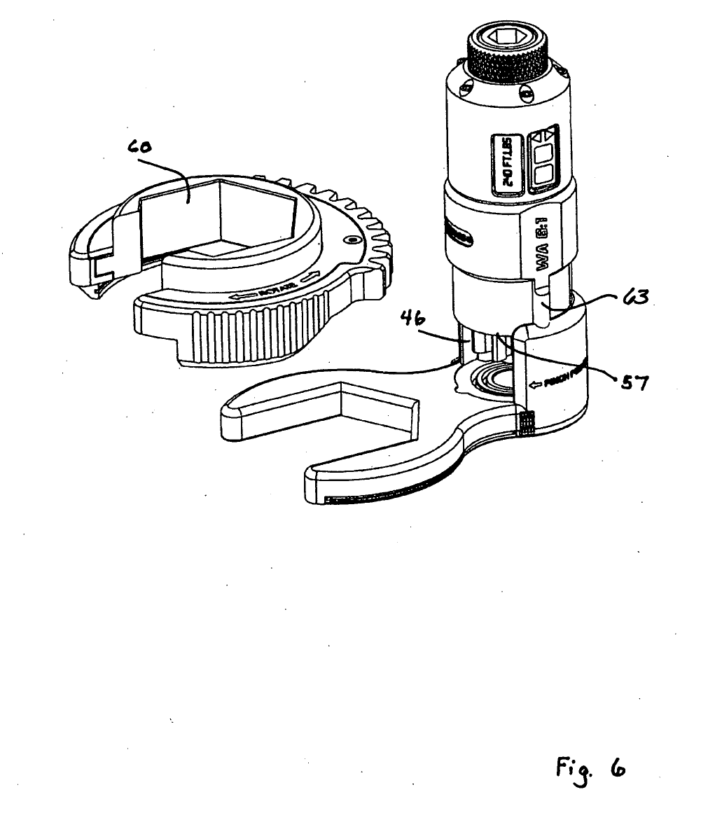

FIG. 7. Blades retracted without cover in place.

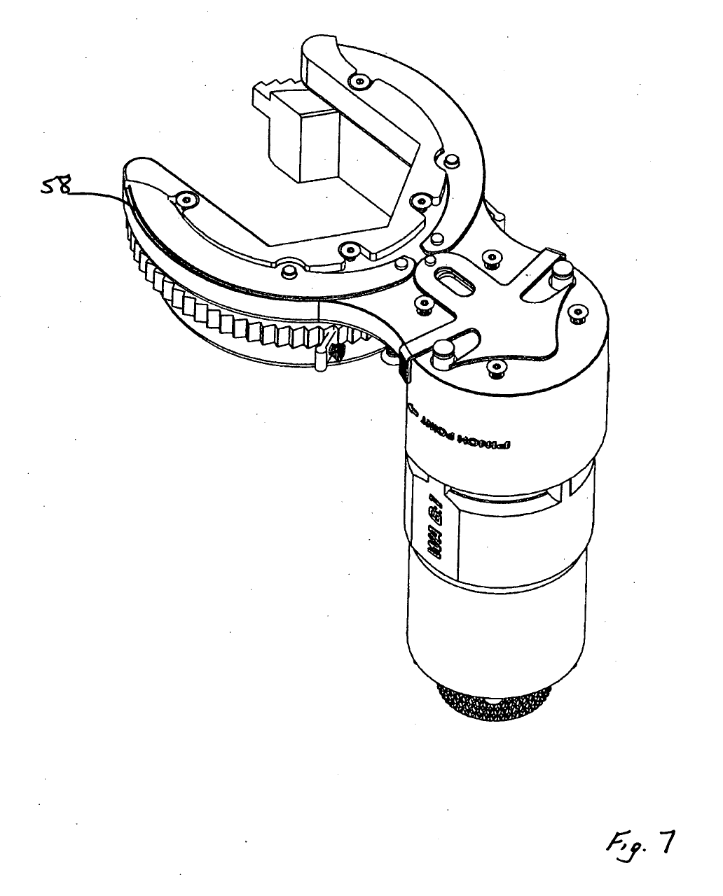

FIG. 8. Alternative embodiment: Tool shown ready for use without planetary multiplier or electronic strain gauge.

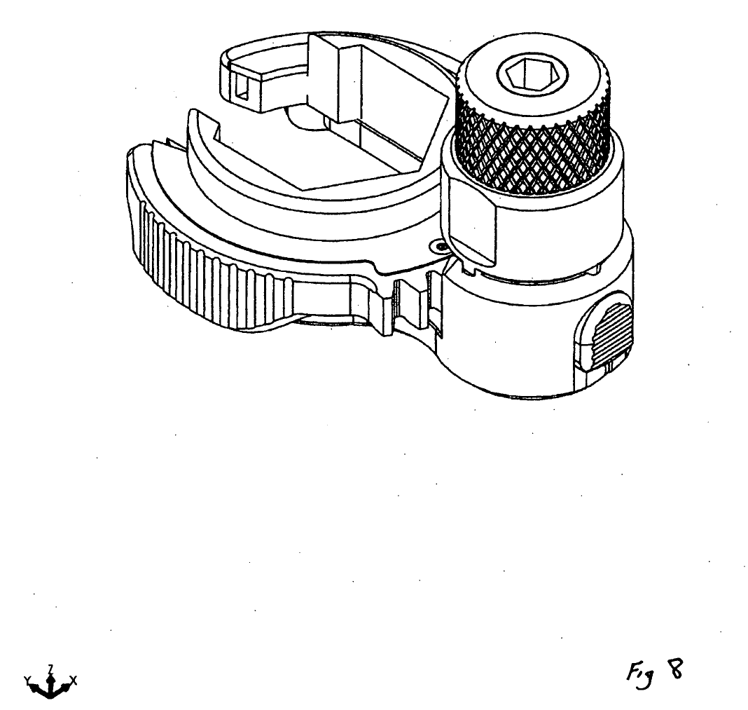

FIG. 9. Alternative blade retraction key mechanism.

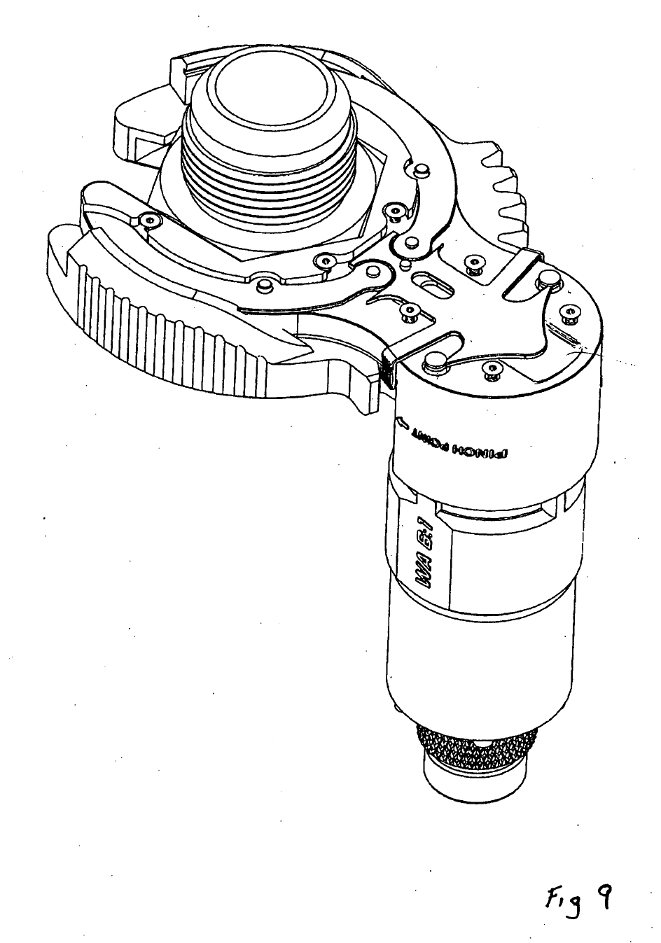

FIG. 10. Alternative ratchet mechanism.

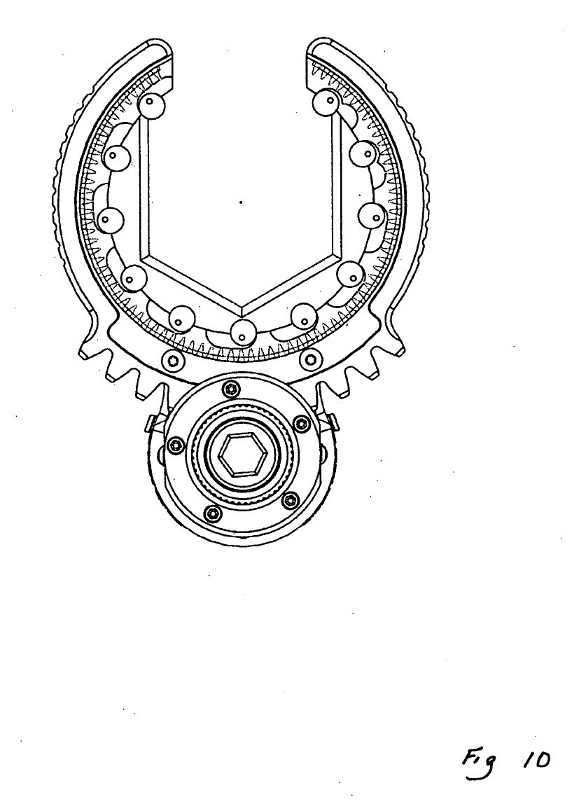

FIG. 11. Tool in driving engagement with a manifold fitting.

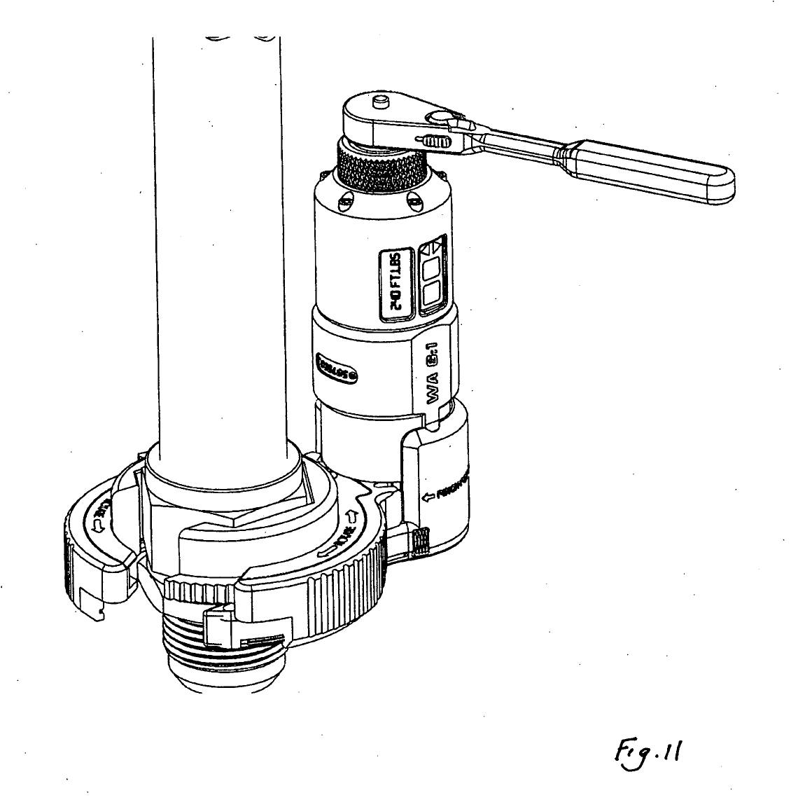

FIG. 12. Tool in driving engagement with a fitting connecting two sections of tubing.

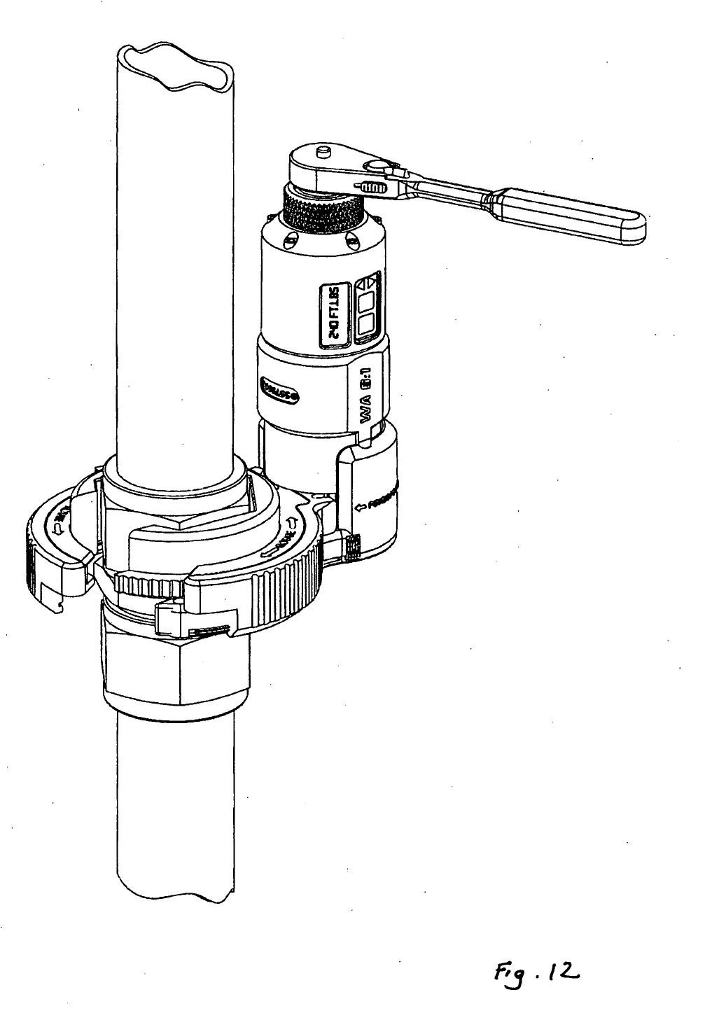

FIG. 13. Tool aligned with fitting and fitting body. Ratchet cover removed to show dogs engaging ratchet teeth.

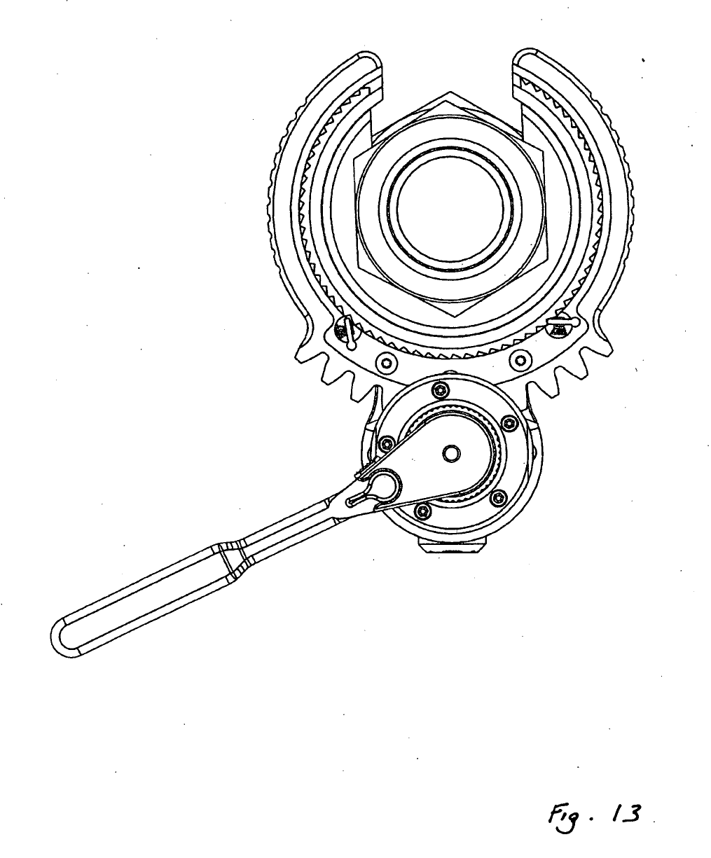

FIG. 14. Sector geared housing advancing ratchet gear and fitting. Cover is removed to show engaging ratchet teeth.

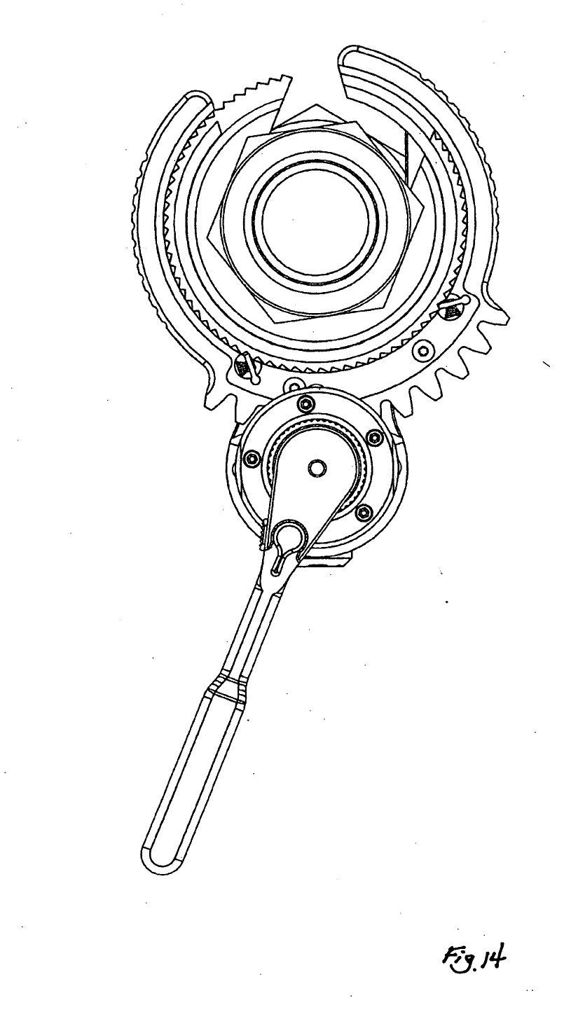

FIG. 15. Sector gear housing rotated to end of travel and ready for reset.

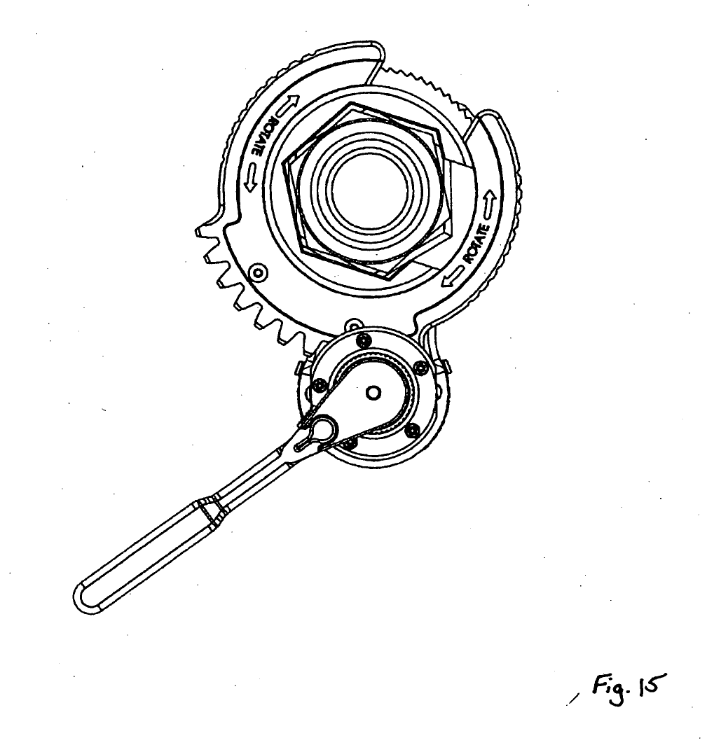

### BRIEF DESCRIPTION OF THE DRAWINGS

The invention will now be described by way of example with reference to the accompanying drawings showing a preferred embodiment of power wrench assembly, and in which:
1. Vertical passageways
2. Pinion gear pocket
3. Arm
4. Slotted pivot hub
5. Spaced apart jaw
6. “C” shaped shoe
7. Spring latch
8. Arm neck
9. Fitting nut
10. Fitting body (non-rotable)
11. Upper hub
12. Ratchet wheel
13. Lower Hub
14. Vertical Rails
15. Ratchet gear pocket
16. Ratchet housing
17. Radial slots
18. Dog pockets
19. Sector gear
20. Circular opening
21. Lower deck ratchet housing
22. Arcuate walls
23. Hub receiving pocket
24. Slotted opening ratchet housing
25. Housing cover
26. Ratchet dogs
27. Ratchet dog springs
28. Cover screws
29. Radial groove ends of rails
30. Key
31. Rear arms of key
32. Forward arms of key
33. Compression spring
34. Extension spring
35. First end of pivoted blades
36. Retractably curved pivot blades.
37. Spring attachment holes
38. Blade cover
39. Cover Screws
40. Ratchet wrench
41. Input stem
42. Electronic strain gauge
43. Sun gear
44. Planetary carosel
45. Telescoping socket
46. Pinion drive gear
47. Bearings (A, B)
48. Planetary housing
49. Gear teeth within barrel
50. Axels
51. Planetary gears
52. Inset key pocket
53. Blades extended
54. Curved blade pockets
55. Closed barrel
56. Slot
57. Lower end of planetary barrel
58. Pivoted blades retracted
59. Planetary fully extended
60. Hexagonal drive socket
61. Hex shaft
62. Lug pockets
63. Planetary barrel lugs
64. Thread hole in planetary barrel

### Included by Description

While the present invention has been illustrated for high torque, high precession applications many variations of this basic principle are easily adapted for application which do not required exact torque values thereby eliminating the need for a strain gauge.

Also applications that do not requiring high torque values could easily use the sector geared crows foot wrenches without a planetary torque multiplier.

Extended sockets can be combined with extended fitting stabilizers to allow the present invention to work with multiple port manifolds. In conclusion the present invention provides optimized utility, safety, and value for workers assembling fittings in confined spaces.

A basic adaptation of the present invention is comprised of two individual wrench-like components. The first component is a crows foot wrench formed with a sector gear at a position opposite the opening at the top end of the crows foot wrench head and a pair segmented wall projected from the lower face of the wrench head and is provided as a rotable bearing surface and follower for a second wrench head substantially circular is provided with a stem and drive gear and sized to fit within the segmented walls of the sector geared crowfoot wrench head. Together the two separated components interlock with one wrench head within the other to permit meshed engagement of the sector geared apron of the first wrench component with the pinion drive gear of the second wrench component. This very basic assembly is functional without any ratcheting feature. While this basic mode requires repositioning the sector geared wrench head during tightening or loosening a fitting nut it also provide an very compact assembly footprint enabling use in confined locations.

While the present invention has been illustrated with a spur gear driving a conventional gear form it will be obvious that a similar construction could be achieved with a worm gear engaged with a worm gear sector on the perimeter of the crows foot ratchet drive housing.

Also not shown is a motor drive engaged with the input planetary that would be either mechanically or electronically controlled for automatic reciprocating clockwise and counter clock wise input to result in continuous rotation of the ratchet gear disposed for cooperative response to the motorized input.

The present invention has been illustrated with hexagonal sockets and a slotted pivot base adapted for use with conventional fluid fasteners, it should be obvious that the present invention could be reconfigured for a wide range of geometric shapes both at the ratchet driven socket and the circular stabilizing head piece.

The present invention has been illustrated with a 9 tooth sector gear segment. The number of teeth provided is variable to meet work envelope requirement by addition or subtraction of teeth. Gear tooth pitch is variable depending on torque requirements.

1. The invention includes a system for installing or removing a fluid fitting with a tool comprised of an arm with a rotable drive gear arm at a first end and a slotted pivot support hub at a second end, adapted for meshed driving engagement with a pivot pocket supported sector geared housing in driving engagement with a ratcheting drive socket.
B. Including a retractable latching mechanism comprised of extensible spring biased blades and retraction key.
C. Pinion gear is mounted on arm at mounting distance appropriate for engagement with a sector gear.
D. Drive gear is a spur gear
E. Sector gear is a spur gear
F. Drive gear is a worm gear
G. Spector gear is a worm wheel segment.

A gear drive system for two wrenches:

Comprised of a sector gear on a first common axis slotted for engagement with a fitting head with coaxial pivot, and a driving gear opposite a slotted coaxial pivot on a second wrench head

A gear drive system for two wrenches:

Comprised of a sector gear on a first slotted wrench head, and a driving gear on a second slotted wrench handle.

Includes a rotable hub on the first wrench for stabilizing rotation of a second wrench around a common axis pivot hub when a pinion gear of the first wrench is engaged with the sector geared annulus of a second wrench head.

Second wrench head includes a ratchet.

Second wrench head includes a one way clutch.

An arm with a pivot hub at a first end and driving gear at a second end for meshed engagement with a sector geared wrench head provide with a hub receiving pocket.

An arm with a drive gear at a first end and pivot station at a second end, joinable with sector slotted sector geared head With a mutually complimentary pivot station.

2. A retractable capture strategy for coupling a pivot hub with a slotted pocket.

A retractable capture mechanism for coupling a pivot hub with a pivot platform with a grooved annulus and a slotted pocket, defined by two spaced apart arcuate walls.

What is claimed is:

1. A geared drive assembly for rotating a fitting nut, comprising:
a slotted pivot hub having an opening defined by a pair of spaced-apart arms at a first end and a receiver at a second end,
wherein the opening is adapted to engage a fitting;
a ratchet housing pivotally secured to the slotted pivot hub,
wherein the ratchet housing comprises a sector gear on an exterior circumference of the ratchet housing;
a drive gear positioned within the receiver of the slotted pivot hub, the drive gear comprising:
a drive carousel having a drive socket at a first end and a pinion gear at a second end; and
a housing to encase the drive carousel;
wherein the pinion gear meshes with the sector gear, causing rotation of the ratchet housing when the drive socket is rotated.

2. The assembly of claim 1, further comprising:
a ratchet wheel having an inner surface adapted to engage a fitting nut,
wherein the ratchet wheel is pivotally secured on an inner surface of the ratchet housing to allow rotation within the ratchet housing in at least one direction.

3. The assembly of claim 1, wherein an interior surface of the ratchet housing is adapted to engage a fitting nut.

4. The assembly of claim 1, further comprising:
a locking mechanism disposed on a bottom surface of the slotted pivot hub,
wherein the locking mechanism engages the ratchet housing to maintain an alignment of the slotted pivot hub and the ratchet housing.

5. The assembly of claim 4, wherein the locking mechanism comprises:
a pair of retractable blades attached to the slotted pivot hub,
wherein the pair of retractable blades are adapted to engage a pair of radial slots disposed on the ratchet housing.

6. The assembly of claim 1, wherein the drive gear further comprises:
a planetary gear set in mechanical engagement with the drive carousel.

7. The assembly of claim 6, wherein the planetary gear set causes an increase in a torque exerted by the pinion gear compared to the torque applied to the drive carousel.

8. The assembly of claim 1, wherein a mechanical advantage provided by the pinion drive gear engaged with the sector gear is about 5 to 1.

9. The assembly of claim 1, wherein a mechanical advantage provided by the pinion drive gear engaged with the sector gear is less than 5 to 1.

10. The assembly of claim 1, wherein a mechanical advantage provided by the pinion drive gear engaged with the sector gear is greater than 5 to 1.

11. The assembly of claim 2, further comprising:
a plurality of ratchet teeth disposed on an exterior of the ratchet wheel;
a spring biased pivoted ratchet dog attached to the ratchet housing,
wherein the ratchet dog contacts the plurality of ratchet teeth, thereby translating reciprocating rotation of the ratchet housing engaged with the pinion gear to incrementally advance the ratchet wheel.

12. The assembly of claim 1, further comprising:
a pair of arcuate walls extending from a bottom plane of the ratchet housing,
wherein the pair of arcuate walls slidingly engage an exterior surface of the spaced-apart arms of the slotted pivot hub, thereby maintaining axial alignment of the slotted pivot hub with the ratchet housing as the ratchet housing is rotated by the pinion gear.

13. The assembly of claim 4, further comprising:
a plurality of rails extending from the drive gear through the slotted pivot hub,
wherein the locking mechanism engages the plurality of rails when positioned in a locked position, thereby preventing the drive gear from dislodging from the receiver of the slotted pivot hub.

14. The assembly of claim 1, further comprising:
a plurality of slots arranged in parallel and traversing a line from a first end of the receiver to a second end of the receiver,
a plurality of lugs disposed on an exterior of the housing of the drive gear, wherein each of the plurality of lugs slidingly engages a corresponding slot of the plurality of slots to prevent rotation of the drive gear within the receiver.
